(19) United States
(12) Patent Application Publication
(10) Pub. No.: US 2003/0024790 A1
(43) Pub. Date: Feb. 6, 2003

(54) Apparatus for monitoring coins discharged from a coi dispenser

(76) Inventors: Victor A. Quattrini, Merrimac, MA (US); Robert J. Pitman, Beverly, MA (US); Paul O. Stump, Topsfield, MA (US); David E. Pheifer, Sudbury, MA (US)

Correspondence Address: PERMAN & GREEN, 425 POST ROAD, FAIRFIELD, CT, 06824, US

(21) Appl. No.: 10/199,204

(22) Filed: Jul. 18, 2002

Related U.S. Application Data
(60) Provisional application No. 60/308,977, filed on Jul. 31, 2001.

(51) Int. Cl. G07D 9/00; G07D 9/04; G06F 7/00; G06F 9/00; G07F 9/08; G06F 19/00

(52) U.S. Cl. 194/217; 453/58

(57) ABSTRACT

A device for dispensing coins is described which is constructed with a sensor for generating a signal when a coin is dislodged from the coin canister. Through a system of sensors, the travel of the coin to the user can be tracked and confirmed. A method is described which times the sequence of coin travel and compiles the information for use by the microprocessor of the dispenser or host device for accounting, coin inventory and other purposes.

### FIELD OF THE INVENTION

An automatic coin dispenser for use as a component of a point of sale terminal, automatic teller machine, cash register, or the like is provided with a system of sensors which generate data for monitoring the discharge of coins from the dispenser.

### BACKGROUND OF THE INVENTION

Automatic coin dispensers form an integral part of cash registers and other point of sale terminals, as, well as automated teller machines and the like. The coin dispenser is generally manufactured and supplied as a plug in unit to the transaction terminal system. The transaction terminal is used to initiate and record a transaction such as a sale, bank withdrawal or deposit and other types of transaction which require the dispensing of change. A system of this type is described in U.S. Pat. No. 5,366,404, which issued on Nov. 22, 1994 and owned in common with this application. The disclosure of the '404 patent is hereby incorporated herein by reference, in its entirety.

A transaction terminal system may consist of a main control computer to which multiple terminals are connected. Each terminal is connected to the control computer and reports data relating to a transaction. The coin dispenser is constructed with a separate microprocessor which controls the dispensing of coins in response to signals from the terminal. The signal from the terminal may vary from a flat sum to be dispensed to the individual denominations of the coins to be dispensed.

A coin dispenser which is representative of the prior art is described in U.S. Pat. No. 5,830,055 which is also owned in common with the subject application. The disclosure of the '055 is incorporated herein by reference, in its entirety. The operation of the coin dispenser is controlled by a microprocessor built in to the dispenser. The coin dispenser shown in the '055 patent may include a series of upright cylindrical receptacles designed to hold a stack of coins of a particular denomination. Coins are dispensed by the actuation of a striking mechanism such as a solenoid controlled striker. The striker engages the bottom coin of a stack and pushes the coin through a slot at the bottom of the cylindrical receptacle. The coin then falls by gravity along a ramp to the coin cup of the dispenser , or alternatively to an interface with the transaction terminal runway on which it is directed to the user. The coin dispenser microprocessor generally is designed to receive a signal indicative of the total sum of change to be dispensed, calculate the individual coins to be dispensed and energize the solenoids needed to dispense the proper amount of change. The microprocessor could also receive a command to dispense specific coins directly. The microprocessor of the dispenser also keeps track of the coins remaining in the dispenser and other data to facilitate the use of the coin dispenser in a larger system. In general the firing of the solenoid is used to provide the confirmation that a coin is dispensed and this information can be compiled and used for accounting purposes. The basic function of the coin dispenser does not vary according to the application in which it is used except to provide a compatible interface with the host system.

### SUMMARY OF THE INVENTION

In the coin dispenser of this invention a monitor is provided to confirm the discharge of a coin from the dispenser. The discharge of the solenoid initiates a cycle of data analysis which relies on the confirmation of the coin discharge from the dispenser to provide accounting data. To accomplish this function a sensor is positioned immediately upstream of the discharge ramp at the exit of each of the cylindrical coin receptacles. In the preferred embodiment, the sensor is a piezoelectric material which generates a voltage signal when flexed. The piezoelectric material is formed as a series of flaps positioned in the coin passage at the exit of the coin from the coin holder. The coin, under the force of the solenoid actuated striker deflects the sensor flap and generates a signal which is sent to the microprocessor. Other types of sensors may be used, for example, an optical sensor which is positioned to allow the coin to pass the exit and disrupt the continuity of the optical sensor.

A removable canister is used to retain the coins and facilitate loading and unloading. When the canister is properly installed in the dispenser, a switch is actuated to confirm that the supply of coins is present. To further insure the integrity of the dispenser after installation a photo optical sensor is placed downstream of the coin discharge sensor to sense the passage of coins down the chute or runway of the host device or coin dispenser. This data is integrated into the overall data received and processed by the microprocessor of the coin dispenser or host system to obtain a full analysis of the operation of the coin dispenser. These data are integrated with other data commonly sensed such as the status of the coin supply in a particular coin column of a canister. Such data is especially useful in applications in which the host device is unsupervised. Such as ATM's, self-check out systems, and kiosks.

### DESCRIPTION OF THE DRAWING

The invention is described in more detail below with reference to the attached drawing in which:

FIG. 1a is a perspective view of a coin dispenser of the type used in association with this invention with the coin canister poised for installation;

FIG. 1b is a perspective view of the exit of the transaction terminal;

FIG. 2 is a close up view of the dispenser mechanism with the sensor of this invention;

FIGS. 3a-3c are flow diagrams showing the functioning of the coin dispenser monitoring system of this invention;

FIG. 4 is a block diagram of the coin dispenser monitoring system of this invention;

FIG. 5 is a schematic diagram of the canister discharge sensor use in this invention;

FIG. 6 is a circuit diagram of the interface of the canister discharge sensor;

FIG. 7 is an illustration of the transaction terminal runway exit sensor;

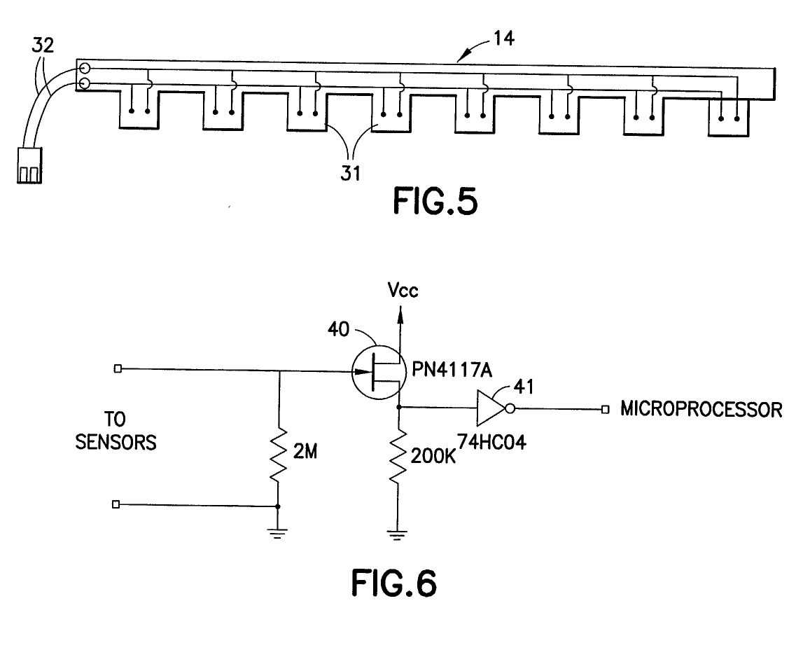

FIG. 8 is a circuit diagram of the interface of the transaction terminal runway exit sensor; and

FIG. 9 is a circuit diagram of the interface of the canister position sensor.

### DESCRIPTION OF THE PREFERRED EMBODIMENT

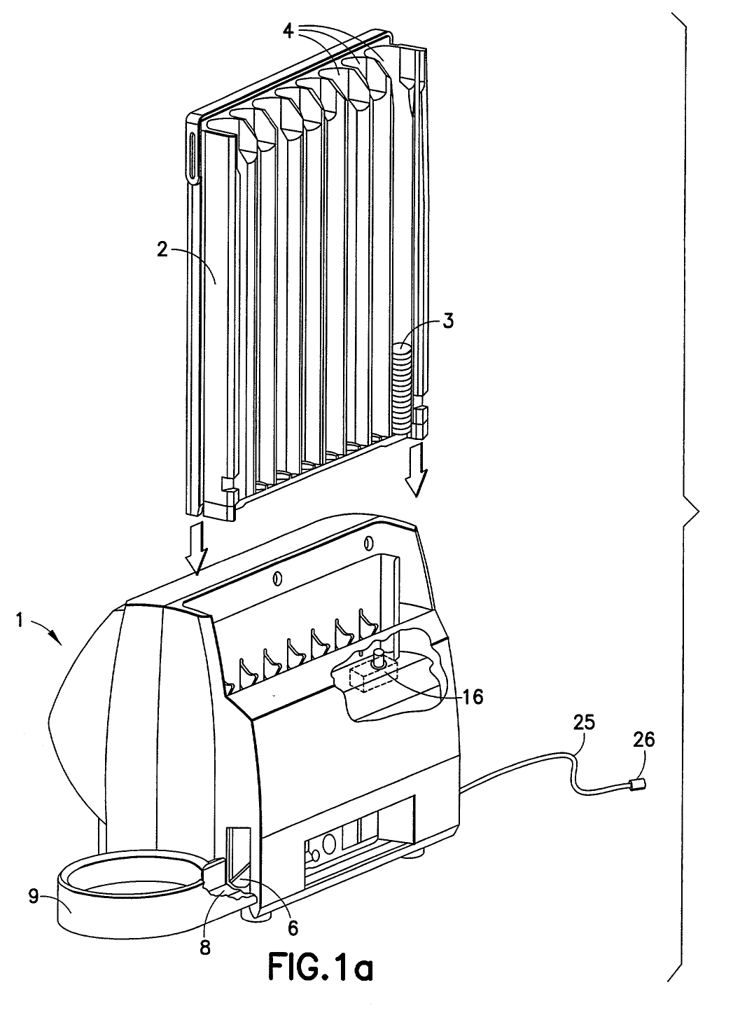

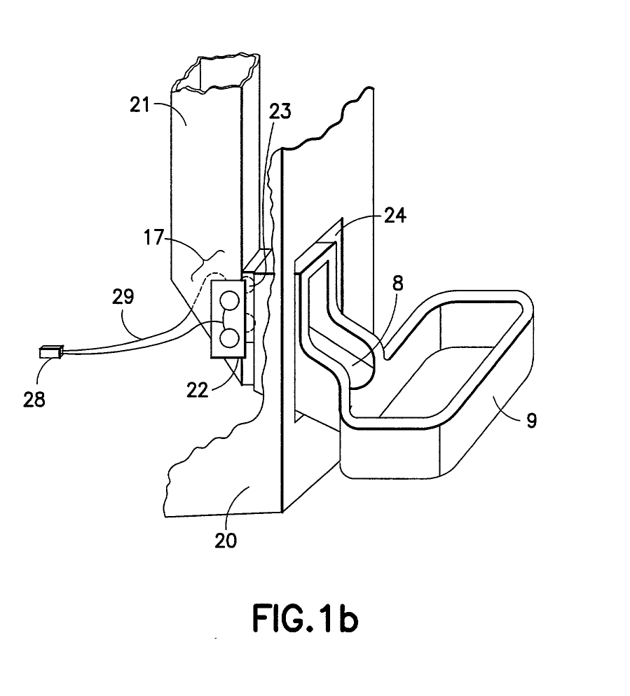

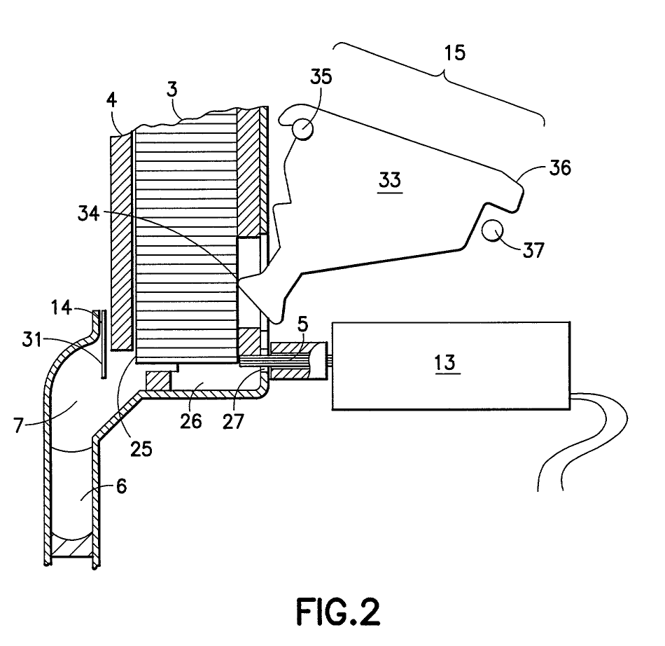

The monitoring system of this invention is designed for use in a coin dispenser 1, an example of which is shown in FIG. 1. Coin dispenser 1 includes a coin canister 2 which contains a supply of coins divided by denomination into multiple stacks 3. Each stack of coins is inserted into a cylindrical column shaped receptacle 4 from which the coins are dispensed by the action of a solenoid powered striker 5, as shown in FIG. 2. Striker 5 engages the lower most coin through opening 27 in canister 2. The lower most coin is pushed out of receptacle 4 through an opening 25 at the bottom 26 of the column onto a ramp 6 which allows the coin to travel out of the coin dispenser. The ramp 6 receives the coins from coin discharge port 7.

The ramp 6 may interface with a coin dispenser cup 9 in a stand alone application or with a host device delivery system which may consist of a chute 21 mounted within a frame 20 of the host device (not shown). As shown in FIG. 1b, the chute 21 connects with a runway 8 which directs the coins to a tray 9 at the coin exit 24 of the host device. As indicated above, the host device can be adapted for a wide variety of applications, for example point of sale terminals, cash registers, automated teller machines, automated check out terminals, kiosks and the like.

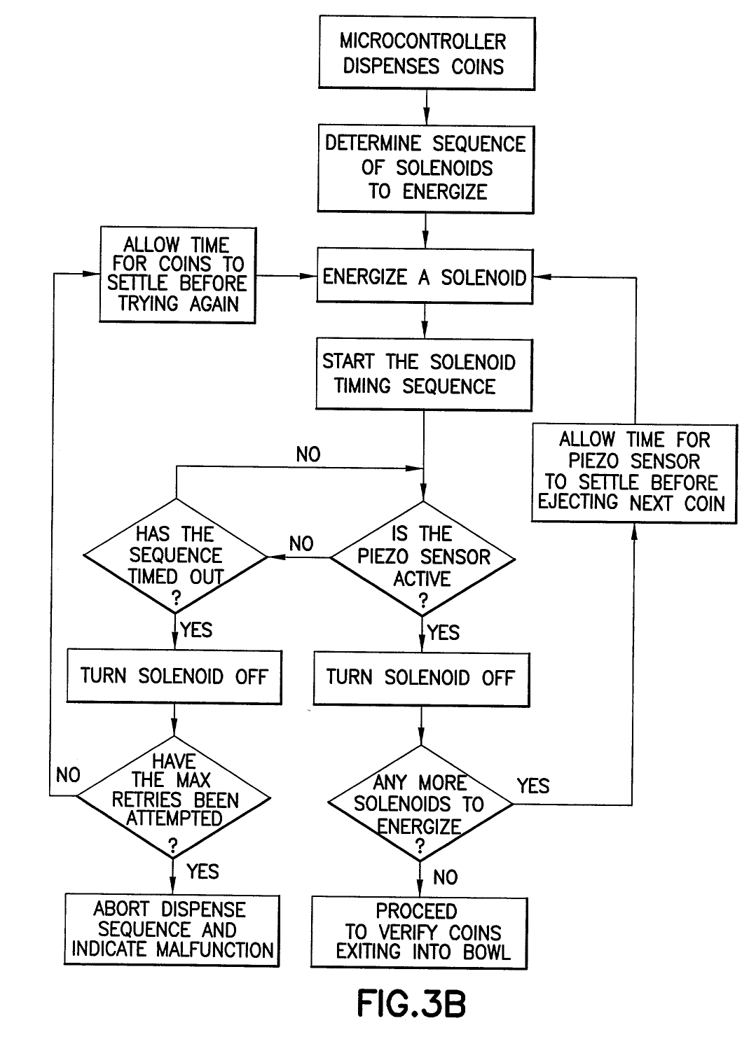

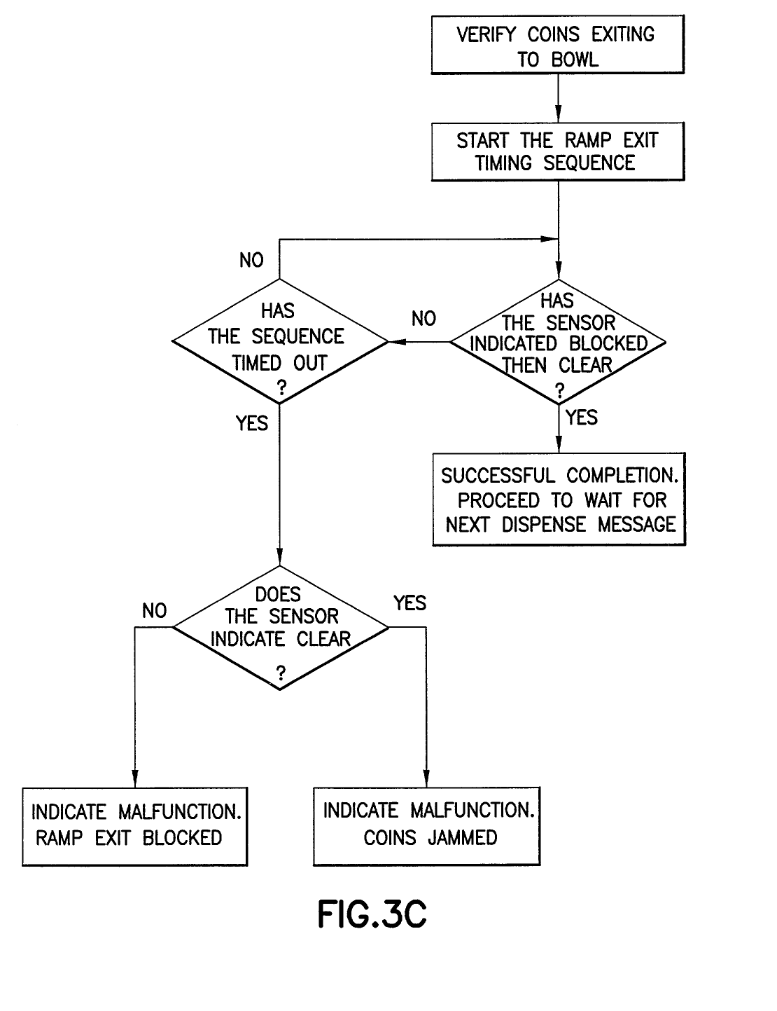

As shown in FIG. 4, the monitoring system of this invention consists of a combination of sensors 14-17 strategically placed within the dispenser or host system to track the progress of coins through the coin dispenser 1 and the host transaction terminal. The key sensor component of this invention is the canister discharge sensor 14 which in the preferred embodiment is constructed, as shown in FIG. 5. Sensor 14 is a flexible piezoelectric PVDF polymer film that generates a voltage when the film is flexed from a quiescent state. The sensor is shaped as an elongated element whose length extends across the width of the canister. Depending rectangular projections or flaps 31 are die cut to extend downward into the discharge opening 7 so as to interfere with the free passage of the coins. Leads to each sensor are screen printed into the laminated film to provide electrical access to the individual sensors. When a coin is dispensed from any of the canister columns through discharge opening 7, a flap 31 adjacent to the column selected will be deflected by the coin as it is discharged through opening 7. This deflection generates a voltage signal at the output leads 32 of sensor 14. When using a piezoelectric film available from Measurement Specialties, Inc. Sensor Products Div., of Valley Forge, Pa., voltages in excess of 15 volts were obtained by this action. Depending on the position of the discharge opening 7 in relation to the bottom of the coin stack, the discharge sensor signal will reliably occur within 15 to 25 milliseconds after energizing the solenoid. This timing data can be used by the microprocessor to determine if a malfunction has occurred. In one embodiment, as shown in FIG. 5, the flaps act as individual sensors for each stack of coins and are connected in parallel to a common output lead. In this configuration, there is no differentiation of the individual stack/denomination by the sensor alone. By modifying the printed circuits laminated into sensor 14, the signals from individual flaps can be isolated and transmitted to microprocessor 10 for independent recognition. This enables the microprocessor 10 to determine the column from which the coin is dispensed and provides data which is usable for transaction accounting as well as the status of the coin supply. Either of these configurations would avoid accounting errors based on solenoid firing data where there may be a failure of the dispensing mechanism downstream of the solenoid. The film type of sensor is therefore, readily adaptable to provide a discrete sensing capability for each stack of a canister.

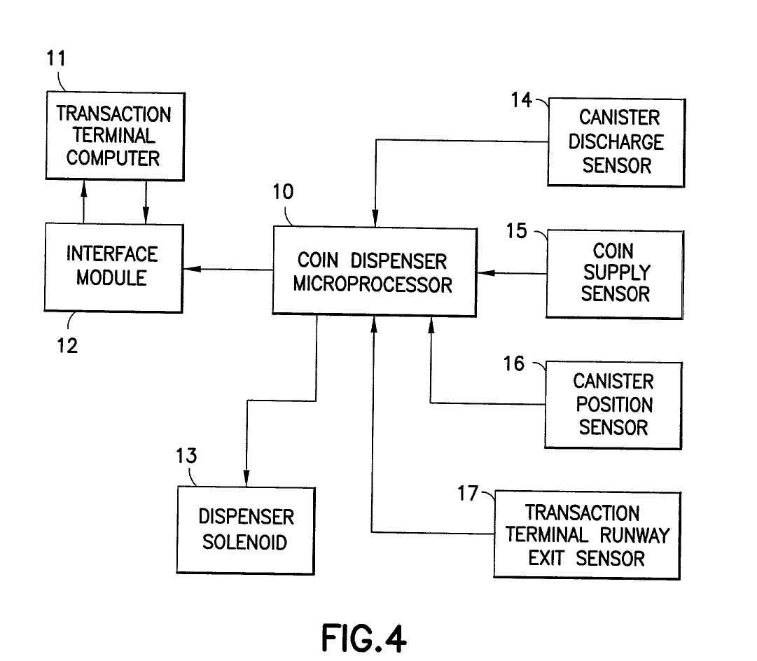

FIG. 6 is an illustration of a possible interface circuit for isolating the signals generated by the sensor 14 and amplifying to provide sufficient current level for use by microprocessor 10. To accomplish this, transistor 40 is connected as shown in FIG. 6 to isolate the voltages generated by sensor 14. Current amplifier 41 boosts the current of the signal from the sensor 14 for use by microprocessor 10.

Sensor 14 may employ other sensing devices, such as capacitive sensing elements, inductive sensing elements through-beam, reflective, fiber optic, microswitch, acoustic pick-up, an accelerometer and others.

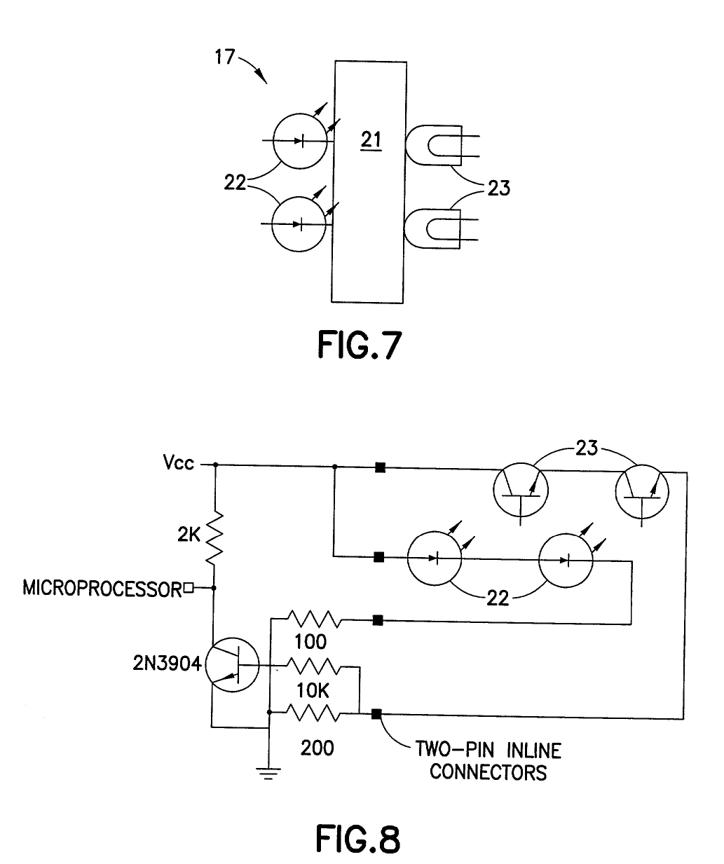

Another sensor of the monitoring system is positioned at the exit 24 of the coin chute 21 contained in the host transaction system, as shown in FIG. 1b or a stand alone dispenser. The sensor 17 consists of a light source, such as a pair of light emitting diodes 22 which emits a light beam across the coin path in chute 21. The light beam is collected on the opposite side of the coin path by a pair of photosensitive diodes 23 aligned with diodes 22. Coins falling through the chute 21 to the tray 9 will interrupt the light beam causing a voltage pulse to be generated at the output of sensor 17. Depending on the coin delivery apparatus of the host device, a characteristic time period can be determined at which the coin will reach the transaction terminal runway exit 24 under normal conditions. Again this timing data can be correlated with other timing signals to confirm normal operation or obtain a malfunction indication. Since sensor 17 could be mounted on the host device, the coin dispenser can be provided with extended lead 25 and connector 26 for interconnection with lead 29 through connector 28 from the sensor 17. Although sensor 17 is indicated as a photoelectric sensor, any appropriate sensor could be used that can be actuated by the coin moving past the coin exit 24 of the host device. An illustration of an appropriate interface circuit for sensor 17 is shown in FIG. 8.

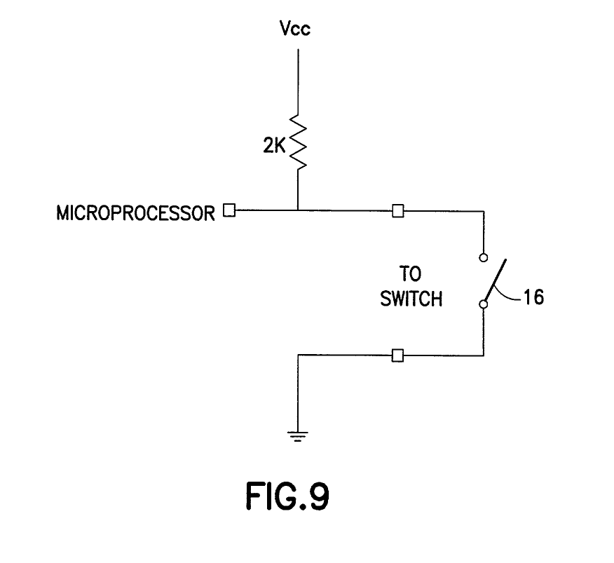

To insure proper installation of the coin canister 2, a microswitch 16 is positioned at the seat for the canister. Full insertion of the canister 2 in coin dispenser 1 will close switch 16 resulting in a clear signal being sent to the microprocessor 10. Sensor/switch 16 can be any typical pressure actuated, optical or proximity switch, which is actuatable by the proper installation of the coin canister 2. The signal generated by actuation of switch 16 is used to prevent energization of a solenoid when the canister is not present or is improperly installed. The signal can also be used as a security feature or to establish time stamped history of canister access for refill and other functions. A simple interface circuit suitable for accomplishing this task is shown in FIG. 9.

The depletion of coins in a coin canister is monitored by a sensor 15 which can be accomplished by a series of levers having a cam surface 34 positioned to extend into the cylindrical receptacle 4 and engage the stack of coins 3. The levers 33 are mounted for rotation about axis 35. As shown in FIG. 2, levers 33 are biased via gravity in the clockwise direction. Engagement of the cam surface 34 by the coin stack 3 will rotate lever 33 counter clockwise against gravity. When a stack is depleted beyond a predetermined limit, i.e., below the reach of cam surface 34, lever 33 is released and rotates clockwise under the force of gravity. A flag 36 is formed at the rear surface of lever 33 opposite cam surface 34, and moves essentially up and down with the rotation of the lever. A photo sensor pair 37 is mounted on both sides of the levers 33, as shown in FIG. 1a, to provide an uninterrupted beam when the cam surface 34 is engaged with the stack 3 and, accordingly lever 33 is rotated counter clockwise. Release of the lever sends flag 36 downward to interrupt the beam of sensor pair 37 and generate a signal which is processed by microprocessor 10 to provide a stack depleted signal.

This signal is used to disable the coin dispenser until the canister with a depleted stack can be replaced with full canister or the depleted stack replenished. Similar results can be obtained without levers by using individual optical or proximity sensors or even contact switches for each column.

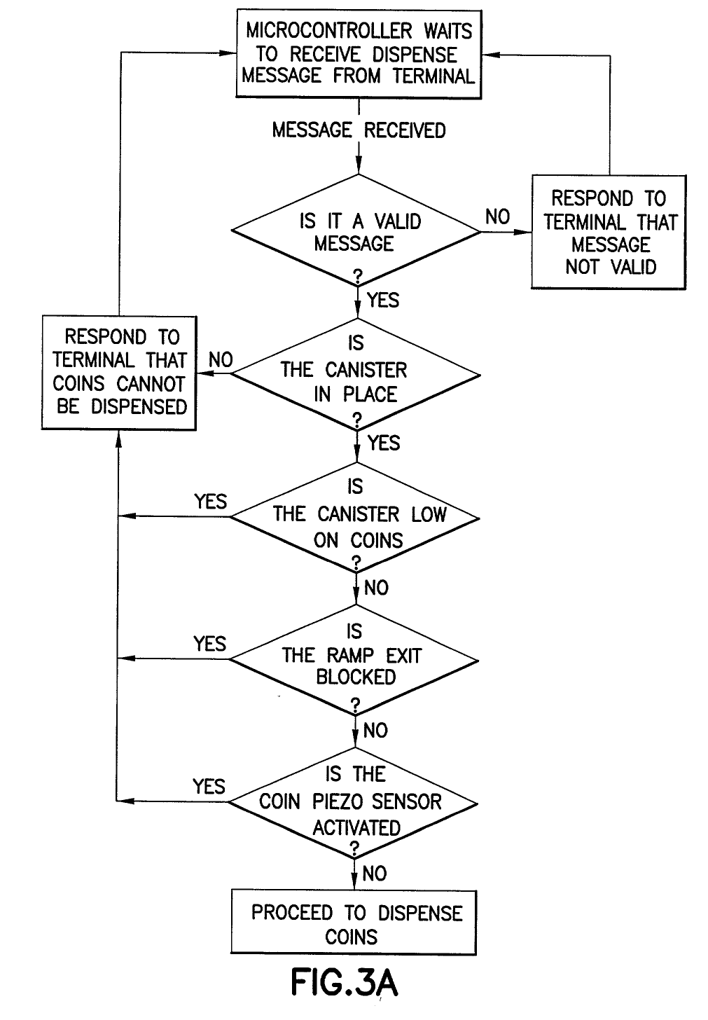

The operation of the coin dispenser is controlled by algorithms imbedded in firmware forming part of the microprocessor 10. The algorithm generates a timed sequence of recognition of the current data supplied by the monitoring system to determine the status of the components of the coin dispenser, as well as the progress of coins dispensed therefrom. The process of this invention as executed by the algorithm is illustrated in the information flow diagrams of FIGS. 3a-3c.

In the sequence of FIG. 3a, a command is sent from the transaction terminal computer 11 to the coin dispenser microprocessor 10 to initiate a change transaction. After confirming the validity of the command, microprocessor 10 checks the canister position, the coin supply sensor 15, and the terminal exit ramp sensor 17. In addition the canister discharge sensor 14 is checked to make sure it is in a quiescent state. If these status checks confirm that the operational status of the coin dispenser is normal, than microprocessor 10 generates commands to energize the solenoids corresponding to the denomination of coins needed to dispense the required amount.

The dispensing sequence is shown in FIG. 3b and is executed for each coin that is dispensed. After determining the sequence of solenoids, the first solenoid is energized and a timer is started. It has been found that the laminated film sensor 14 will exhibit secondary flexing as the flap 31 returns to its initial position after being struck by a coin. A first predetermined period is set up to delay subsequent firing of a solenoid until the flap 31 has returned to the quiescent state. If at the end of that first predetermined period the sensor 14 is still active than a malfunction signal is generated to warn the user and stop the transaction. A second predetermined time period is set which corresponds to the time in which it takes a coin to pass the discharge sensor 14 after a solenoid is energized. Failure to receive a coin discharge signal within the second period indicates a malfunction and the transaction will be aborted.

A third sequence of steps is illustrated in FIG. 3c. In the sequence, the progress of a dispensed coin is monitored. A timer is initiated either by the solenoid firing or by a signal from the discharge sensor 14. The normal time for a coin to travel to the chute exit timer 17 is set for reference. The chute exit sensor 17 will generate a signal indicating a blockage and then a clearing of the passage in the normal condition where a coin passes sensor 17. If the sensor 17 remains blocked or if it does not generate a signal with the predetermined period a malfunction is indicated.

In this manner a simple monitoring system is provided, that allows the coin dispenser to track the travel of a dispensed coin through the system and give a reliable indication of the operational status of the coin dispenser as well as data to accurately record a particular transaction.

We claim:

1. A system for monitoring the operation of a coin dispenser, said coin dispenser having a coin container and a coin discharge mechanism for dispensing coins from said container, said monitoring system comprising:
a first sensor mounted in the dispenser at a position to sense the discharge of a coin from the discharge mechanism and to generate a signal in response thereto;
a microprocessor for receiving said signal from the first sensor;
a storage medium, operationally associated with said microprocessor, for storing a predetermined algorithm; and
wherein said microprocessor processes said signals from said first sensor according to said algorithm to monitor operation of the discharge mechanism.

2. A system for monitoring the operation of a coin dispenser, said coin dispenser having a coin container and a coin discharge mechanism for dispensing coins from said container, said monitoring system, as described in claim 1, wherein said algorithm includes a predetermined timing sequence related to the dispensing of said coins.

3. A system for monitoring the operation of a coin dispenser, said coin dispenser having a coin container and a coin discharge mechanism for dispensing coins from said container, said monitoring system, as described in claim 1, wherein said storage medium further stores a coin data inventory and said microprocessor compares said signals from said first sensor to said coin inventory data to keep track of the amounts of coins dispensed from said coin dispenser.

4. A system for monitoring the operation of a coin dispenser, said coin dispenser having a coin container and a coin discharge mechanism for dispensing coins from said container, said monitoring system, as described in claim 1, wherein the first sensor comprises a piezoelectric element which is deflected by the passage of a coin from the discharge mechanism, said deflection generating an electrical pulse which is received by the microprocessor.

5. A system for monitoring the operation of a coin dispenser, said coin dispenser having a coin container and a coin discharge mechanism for dispensing coins from said container, said monitoring system, as described in claim 1, wherein said coin container comprises a removable canister holding multiple columns of coins to be dispensed by said discharge mechanism, said system further comprising a second sensor, positioned to generate a signal to said microprocessor, when said removable canister is properly positioned in the coin dispenser.

6. A system for monitoring the operation of a coin dispenser, said coin dispenser having a coin container and a coin discharge mechanism for dispensing coins from said container, said monitoring system, as described in claim 5, wherein a first sensor is provided at each of said columns to sense the discharge of a coin from a column and to generate a signal upon the passage of a coin from the discharge mechanism associated with a specific column.

7. A system for monitoring the operation of a coin dispenser, said coin dispenser having a coin container and a coin discharge mechanism for dispensing coins from said container, said monitoring system, as described in claim 6, wherein each of said first sensors comprises a piezoelectric element which is deflected by the passage of a coin from the discharge mechanism, said deflection generating an electrical pulse which is received by the microprocessor and wherein said microprocessor separately compiles the signals from each of said columns to track the coins dispensed therefrom.

8. A system for monitoring the operation of a coin dispenser, said coin dispenser having a coin container and a coin discharge mechanism for dispensing coins from said container, said monitoring system, as described in claim 1, wherein said discharge mechanism discharges the coins into a discharge chute, said chute transporting said coins in a predetermined path, said path ending in a receptacle accessible to the user, said system further comprising a third sensor, positioned in said chute near said receptacle, to generate a signal to said microprocessor upon the passage of a coin to the receptacle.

9. A system for monitoring the operation of a coin dispenser, said coin dispenser having a coin container and a coin discharge mechanism for dispensing coins from said container, said monitoring system, as described in claim 8, wherein said algorithm causes said microprocessor to time the period of time from receipt of said signal from said first sensor to the receipt of the signal from said third sensor and compares said time period to a predetermined time to monitor operation of the dispenser.

10. A system for monitoring the operation of a coin dispenser, said coin dispenser having a coin container and a coin discharge mechanism for dispensing coins from said container, said monitoring system, as described in claim 5, wherein a fourth sensor is positioned in operative association with the coin columns of the coin canister to generate a signal to the microprocessor when the supply of coins is depleted.

11. A system for monitoring the operation of a coin dispenser, said coin dispenser having a coin container and a coin discharge mechanism for dispensing coins from said container, said monitoring system comprising:
a removable canister holding multiple columns of coins to be dispensed by said discharge mechanism operatively associated with each column;
multiple first sensors mounted in the dispenser at a position to sense the discharge of a coin from each of the columns of said canister and to generate a signal upon the discharge of a coin from a column of said canister;
a second sensor, positioned to generate a signal, when said removable canister is properly positioned in the coin dispenser;
a discharge chute for receiving coins ejected from said canister, said chute transporting said coins in a predetermined path, said path ending in a receptacle accessible to the user;
a third sensor, positioned in said chute near said receptacle, to generate a signal upon the passage of a coin to the receptacle;
a fourth sensor positioned in operative association with the coin columns of the coin canister to generate a signal when the supply of coins is depleted;
a microprocessor for receiving said signals from the first, second, third, and fourth sensors and processing said signals in accordance with a predetermined algorithm to monitor the operation of the dispenser.

12. A system for monitoring the operation of a coin dispenser, said coin dispenser having a coin container and a coin discharge mechanism for dispensing coins from said container, said monitoring system, as described in claim 11, wherein said algorithm includes a predetermined timing sequence related to the dispensing of said coins.

13. A system for monitoring the operation of a coin dispenser, said coin dispenser having a coin container and a coin discharge mechanism for dispensing coins from said container, said monitoring system, as described in claim 11, further comprising a storage medium, operationally associated with said microprocessor, wherein said storage medium stores a coin data inventory and said microprocessor compares said signals from said first sensor to said coin inventory data to keep track of the amounts of coins dispensed from said coin dispenser.

14. A system for monitoring the operation of a coin dispenser, said coin dispenser having a coin container and a coin discharge mechanism for dispensing coins from said container, said monitoring system, as described in claim 11, wherein said first sensor comprises a piezoelectric element which is deflected by the passage of a coin from the discharge mechanism, said deflection generating an electrical pulse.

15. A system for monitoring the operation of a coin dispenser, said coin dispenser having a coin container and a coin discharge mechanism for dispensing coins from said container, said monitoring system, as described in claim 12, wherein said algorithm causes said microprocessor to time the period of time from receipt of the signal from said first sensor to the receipt of the signal from said third sensor and compares said time period to a predetermined time in said timing sequence to monitor operation of the dispenser.

16. A system for monitoring the operation of a coin dispenser, said coin dispenser having a coin container and a coin discharge mechanism for dispensing coins from said container, said monitoring system, as described in claim 12, wherein operation is initiated by a command to dispense an amount of coins and said algorithm further causes said microprocessor to monitor the sequence of first, second, third, and fourth signals, compare said monitored sequence with said timing sequence and abort said dispense command when abnormal operation occurs.

17. A system for monitoring the operation of a coin dispenser, said coin dispenser having a coin container and a coin discharge mechanism for dispensing coins from said container, said monitoring system, as described in claim 12, wherein said timing sequence includes a first predetermined time period corresponding to the time required by the first sensor to return to its quiescent state and a second predetermined time period corresponding to the time, after actuation of the discharge mechanism, a coin normally takes to pass the first sensor and wherein said microprocessor delays the operation of the discharge mechanism during said first time period and terminates operation of the coin dispenser when a signal from the first sensor is not received within said second predetermined time period.

18. A system for monitoring the operation of a coin dispenser, said coin dispenser having a coin container and a coin discharge mechanism for dispensing coins from said container, said monitoring system, as described in claim 12, wherein said timing sequence includes a third predetermined time period corresponding to the time a coin takes to travel to the receptacle and wherein said microprocessor generates an error message when a signal from said fourth sensor is not received within said third predetermined time period.

19. A system for monitoring the operation of a coin dispenser, said coin dispenser having a coin container and a coin discharge mechanism for dispensing coins from said container, said monitoring system, as described in claim 11, wherein said algorithm causes said microprocessor to check the status of said sensors for proper operation before it initiates a dispense command for actuating the discharge mechanism.

20. A system for monitoring the operation of a coin dispenser, said coin dispenser having a coin container and a coin discharge mechanism for dispensing coins from said container, said monitoring system, as described in claim 12, wherein said algorithm causes said microprocessor to generate a timed sequence of recognition of the current data supplied by the monitoring system to determine the status of the components of the coin dispenser and the progress of coins dispense therefrom.

21. A method of monitoring the operation of a coin dispenser, said coin dispenser having a removable coin canister for storing multiple columns of coins and a coin discharge mechanism for selectively dispensing coins from said columns of said canister into a chute for transport to the user, said method comprising the steps of:
initiating a transaction for the dispensing of an amount of coins by energizing said discharge mechanism;
sensing the dispensing of coins from a column of said canister as the coins are discharged and generating a signal in response thereto;
processing said signal in a microprocessor according to a predetermined algorithm to monitor operation of the dispenser.

22. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the steps of:
storing a first predetermined time period in which the coin is normally dispensed from said columns; and
comparing the time of said dispensing signal to the first predetermined time period.

23. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the steps of:
storing data relative to the inventory of coins in the canister wherein denominations of coins are separated according to said columns;
compiling the signals from said dispensing sensor and correlating said signals to the column from which the coin is dispensed;
processing said dispensing signals to determine the accuracy of the amounts dispensed.

24. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the steps of:
sensing the passage of coins from an exit of said chute;
storing a second predetermined time period in which the coin normally takes to travel to said exit; and
comparing the time of said chute exit signal to said second predetermined time period to monitor operation of the dispenser.

25. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the steps of:
sensing the installation of the coin canister in the dispenser and generating a signal in response to proper installation; and
generating a message to the user if no coin canister signal is present.

26. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the steps of:
sensing the presence of coins in a column of said canister and generating a signal when said coin supply in said column is depleted; and
generating a message to the user when said column of coins is depleted.

27. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the step of:
prior to executing a transaction, generating an inquiry to confirm the validity of the transaction command, the canister position, the coin supply, the status of said dispensing sensor, and the status of said exit sensor.

28. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 27, further comprising the steps of:
storing a delay period corresponding to the time in which the dispensing sensor takes to return to its quiescent state;
delaying the execution of subsequent transactions until said delay period is expired.

29. A method of monitoring the operation of a coin dispenser, said coin dispenser having a removable coin canister for storing multiple columns of coins and a coin discharge mechanism for selectively dispensing coins from said canister into a chute for transport to the user, said method, as described in claim 21, further comprising the steps of aborting said transaction if a dispensing signal is not received within said first predetermined time period.
